(19) United States
(12) Patent Application Publication
(10) Pub. No.: US 2013/0224628 A1
(43) Pub. Date: Aug. 29, 2013

(54) FUNCTIONAL LAYER MATERIAL FOR SOLID OXIDE FUEL CELL, FUNCTIONAL LAYER MANUFACTURED USING FUNCTIONAL LAYER MATERIAL, AND SOLID OXIDE FUEL CELL INCLUDING FUNCTIONAL LAYER

(71) Applicant: Samsung Electronics Co., Ltd., (US)

(72) Inventors: Kyoung-seok MOON, Hwaseong-si (JP); Ju-sik KIM, Seoul (KR); Soo-yeon SEO, Seoul (KR); Chan KWAK, Yongin-si (KR); Sung-jin AHN, Anyang-si (KR)

(73) Assignee: SAMSUNG ELECTRONICS CO., LTD., Suwon-si (KR)

(21) Appl. No.: 13/754,197

(22) Filed: Jan. 30, 2013

(30) Foreign Application Priority Data
Feb. 29, 2012 (JP) 10-2012-0021408

(51) Int. Cl. H01M 8/10

(52) U.S. Cl. CPC H01M 8/10
USPC 429/489; 429/479; 429/495; 429/496; 252/521.1; 252/519.5

(57) ABSTRACT

A functional layer material for a solid oxide fuel cell (SOFC) including a ceria ceramic oxide and a metal oxide including a metal, except for zirconium, having a Vegard's slope X represented by Equation 1 and having an absolute value |X| of the Vegard's slope X, wherein 27×10⁵≦|X|≦45×10⁵:

X=(0.0220rᵢ+0.00015zᵢ) (1),

wherein rᵢ is an ionic radius difference between the metal and Ce⁴⁺, and zᵢ is a charge difference between the metal and Ce⁴⁺.

This application claims priority to and the benefit of Korean Patent Application No. 10-2012-0021408, filed on Feb. 29, 2012, and all the benefits accruing therefrom under 35 U.S.C. §119, the content of which is incorporated therein in its entirety by reference.

### BACKGROUND

1. Field

The present disclosure relates to a functional layer material for a solid oxide fuel cell (SOFC), a functional layer manufactured using the functional layer material, and a solid oxide fuel cell including the functional layer.

2. Description of the Related Art

Solid oxide fuel cells (SOFCs), which are high-efficiency environmentally friendly power generation technology for directly converting chemical energy of fuel gas to electric energy, use ion-conductive solid oxide electrolytes. SOFCs have many advantages such as use of low-priced materials relative to other fuel cells, a relatively high permissible level for gas impurities, hybrid power generation capability, and high efficiency. Furthermore, a direct use of hydrocarbon-based fuel without any modification of hydrogen may lead to a simplified fuel cell system and cost reductions.

An SOFC desirably has excellent thermal, mechanical, and electrochemical characteristics due to its high-temperature operating regime. Accordingly, to obtain long-term stability and economical efficiency of commercial SOFC systems, their operating temperature is desirably lowered from a range of 800 to 1,000° C. to a range of 500 to 700° C.

Since the operating temperature of an SOFC may be greatly affected by the resistance of a cathode, numerous efforts have been implemented to reduce that resistance. It was found that when the operating temperature is lower than 800 to 1,000° C., the activity of a cathode may be substantially reduced. Towards that end, perovskite-based mixed ionic-electronic conductive (MIEC) cathode materials having excellent catalyst characteristics and conductivity have been produced and methods of increasing the activity of a cathode by using a complex electrode having a complex electrolyte have been developed.

Although a cathode material, such as a BSCF-based material or a LSCF-based material, is suitable for intermediate temperature solid oxide fuel cell (IT-SOFC), such materials often form a reaction phase with a zirconia-based material electrolyte material, increasing cathode resistance and decreasing performance of the cell as result. Therefore, it would be desirable to prevent a reaction between the cathode and an electrolyte. Thus, there remains a need for an improved fuel cell material.

### SUMMARY

Provided is a functional layer material for a solid oxide fuel cell (“SOFC”), which effectively prevents a reaction between a cathode and an electrolyte.

Provided is a functional layer that is formed using the functional layer material for a solid oxide fuel cell.

Provided is a solid oxide fuel cell including the functional layer.

Additional aspects will be set forth in part in the description which follows and, in part, will be apparent from the description.

According to an embodiment, a functional layer material for a solid oxide fuel cell (“SOFC”) includes a ceria ceramic oxide; and a metal oxide including a metal, except for zirconium, having a Vegard's slope X represented by Equation 1 and having an absolute value |X| of the Vegard's slope X, wherein 27×10⁵≦|X|≦45×10⁵:

X=(0.0220rᵢ+0.00015zᵢ) (1),

wherein rᵢ is an ionic radius difference between the metal and Ce⁴⁺, and

zᵢ is a charge difference between the metal and Ce⁴⁺.

The metal oxide may form a liquid phase at an interface with the ceria ceramic oxide during annealing (heat treatment).

An annealing temperature may be from about 1,200 to about 1,300° C.

The metal oxide may include at least one selected from ZnO, Bi₂O₃, and Co₃O₄.

The ceria ceramic oxide may include at least one heterogeneous element selected from a lanthanide element, a rare earth element, and an alkaline earth metal element as a dopant.

The ceria ceramic oxide may be represented by Formula 1 below:

Ce₁₋ₐMₐO_{3±δ} Formula 1

wherein M is at least one selected from a lanthanide element, a rare earth element, and an alkaline earth metal element;

0<a≦0.3; and

δ is an excess or deficit of oxygen.

M may be at least one selected from lanthanum (La), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu); calcium (Ca), strontium (Sr), barium (Ba), scandium (Sc), and yttrium (Y).

The ceria ceramic oxide may have a fluorite structure.

The metal oxide may be contained in an amount of about 0.1 parts by weight to about 1.0 parts by weight, based on 100 parts by weight of the ceria ceramic oxide.

According to another embodiment, a functional layer for a solid oxide fuel cell (“SOFC”) includes a ceria ceramic oxide represented by Formula 2 below:

Ce_{1-a-b}MₐM′_{b}O_{3±δ}, Formula 2

wherein M is at least one selected from a lanthanide element, a rare earth element, and an alkaline earth metal element,

M′ is a metal, except for zirconium, having a Vegard's slope X represented by Equation 1 below and having an absolute value |X| of the Vegard's slope X, wherein 25×10⁵≦|X|≦45×10⁵;

0<a≦0.3;

0<b≦0.01; and

δ is an excess or deficit of oxygen:

X=(0.0220rᵢ+0.00015zᵢ) (1)

wherein rᵢ is an ionic radius difference between the metal and Ce⁴⁺, and

zᵢ is a charge difference between the metal and Ce⁴⁺.

M may be at least one selected from La, Pr, Nd, Pm, Sm, Eu, Gd, Tb, Dy, Ho, Er, Tm, Yb, Lu, Ca, Sr, Ba, Sc, and Y.

M′ may be at least one selected from Zn, Bi, and Co.

A porosity of the functional layer may be about 10 to about 20 volume %, based on a total volume of the functional layer.

According to another embodiment, a solid oxide fuel cell includes a cathode; an anode facing the cathode; and a solid oxide electrode disposed between the cathode and the anode, wherein the functional layer described above is disposed between the cathode and the solid oxide electrolyte.

The cathode may include a perovskite-type metal oxide represented by Formula 3 below:

ABO_{3±γ}, Formula 3

wherein A is at least one selected from La, Ba, Sr, Sm, Gd, and Ca;

B is at least one selected from Mn, Fe, Co, Ni, Cu, Ti, Nb, Cr, and Sc; and

γ is an excess or deficit of oxygen.

The perovskite-type metal oxide may be represented by Formula 4 below:

A′₁₋ₓA″ₓB′O_{3±γ}, Formula 4

wherein A′ is at least one selected from Ba, La, and Sm;

A″ is different from A′ and is at least one selected from Sr, Ca, and Ba;

B′ is at least one selected from Mn, Fe, Co, Ni, Cu, Ti, Nb, Cr, and Sc;

0≦x<1; and

γ is an excess or deficit of oxygen.

The solid oxide electrolyte may include yttria stabilized zirconia (“YSZ”), scandia stabilized zirconia (“ScSZ”), a ((La, Sr)(Ga, Mg)O₃) material, or a mixture thereof.

A non-conductor reaction layer may be disposed between the functional layer and the solid oxide electrolyte, and a thickness of the non-conductor reaction phase may be about 0.5 micrometers (“μm”) or less.

### BRIEF DESCRIPTION OF THE DRAWINGS

These and/or other aspects will become apparent and more readily appreciated from the following description of the embodiments, taken in conjunction with the accompanying drawings in which:

FIG. 1 shows an embodiment of a process wherein a growth rate of ceria-based ceramic oxide particles increases and necking rate of ceria-based ceramic oxide particles also increases by adding a dopant;

FIG. 2 is a scanning electron microscopy (“SEM”) image showing a change in an interface structure due to addition of a dopant;

FIG. 3 is a schematic cross-sectional view of an embodiment of solid oxide fuel cell (“SOFC”);

FIG. 4 is a SEM image of a sectional view of a cell of Comparative Example 5;

FIG. 5 is a graph of counts versus energy (kiloelectronvolt, keV) showing the results of an energy dispersive X-ray spectroscopy (“EDS”) analysis of components disposed between an electrolyte (“ScSZ”) and a functional layer (“GDC”) in a cell of Comparative Example 5;

FIG. 6 shows a SEM image of a sectional view of a cell of Example 4;

FIG. 7 is a graph of counts versus energy (kiloelectronvolts, keV) showing the results of an EDS analysis of components between an electrolyte (“ScSZ”) and a functional layer (“GDC”) in a cell of Example 4;

FIG. 8A shows a SEM image of a GDC functional layer including no additives in a cell of Comparative Example 5;

FIG. 8B shows a SEM image of a GDC functional layer including Co₃O₄ in a cell of Example 4;

FIG. 9 is a graph of voltage (Volts, V)and power (Watts, W) versus current (Amperes, A) showing the performance of a cell of Comparative Example 5;

FIG. 10 is a graph of voltage (Volts, V) and power (Watts, W) versus current (Amperes, A) showing performance of a cell of Example 4;

FIG. 11 is a graph of imaginary impedance Zᵢₘₐ (ohms-square centimeters, ohm×cm²) versus real impedance Zᵣₑₐₗ (ohms-square centimeters, ohm×cm²) which shows a measurement result of impedances of cells of Examples 1-3 and Comparative Examples 1-4; and

FIG. 12A illustrates an enlarged SEM image of GDC functional layers of symmetrical cells of Examples 2;

FIG. 12B illustrates an enlarged SEM image of GDC functional layers of symmetrical cells of Examples 3;

FIG. 12C illustrates an enlarged SEM image of GDC functional layers of symmetrical cells of Comparative Example 1;

12D illustrates an enlarged SEM image of GDC functional layers of symmetrical cells of Comparative Example 4.

### DETAILED DESCRIPTION

Reference will now be made in detail to embodiments, examples of which are illustrated in the accompanying drawings, wherein like reference numerals refer to like elements throughout. In this regard, embodiments may have different forms and should not be construed as being limited to the descriptions set forth herein. Accordingly, embodiments are merely described below, by referring to the figures, to explain aspects of the present disclosure. Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an” and “the” are intended to include the plural forms as well, unless the context clearly indicates otherwise. The term “or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

A functional layer material for a solid oxide fuel cell (“SOFC”) according to an embodiment may include a ceria-based ceramic oxide and a metal oxide including a metal, except for zirconium, having a Vegard's slope X represented by Equation 1 and having an absolute value |X| of the Vegard's slope X, wherein 27×10⁵≦|X|≦45×10⁵.

X=(0.0220rᵢ+0.00015zᵢ) (1)

In Equation 1, rᵢ is an ionic radius difference between the metal and Ce⁴⁺, and zᵢ is a charge difference between the metal and Ce⁴⁺.

The functional layer material may be used to manufacture a functional layer for an SOFC. The term ‘functional layer’ used herein refers to a layer interposed between an electrode (e.g., an cathode) and an electrolyte in order to minimize or suppress an undesired chemical reaction between the electrode and the electrolyte which can occur during the sintering of an SOFC.

A functional layer for preventing a reaction between a cathode and an electrolyte is designed to prevent an increase in resistance created by a phase formed by a reaction between the electrolyte and dispersed atoms of the cathode. In this regard, if the functional layer has a large number of pores, the reaction may not be prevented. As a result, ion conductivity, and thus performance of a fuel cell, will be reduced. However, when the functional layer has a substantially dense structure, the reaction may be prevented, since the functional layer will slow down diffusion of atoms from a cathode layer. Thus, to function, the functional layer is desirable to have only a certain number of pores. The functional layer material for an SOFC according to an embodiment may include an additive that causes necking between particles and promotes growth of the particles of the ceria-based ceramic oxide. The porosity of a functional layer is desirable to be selected from the range of about 10 to about 20 percent by volume (“volume %”), based on a total volume of the functional layer to enable manufacture of a functional layer for effectively preventing cathode atoms from being diffused.

According to an embodiment, the ceria-based ceramic oxide may include ceria doped with at least one heterogeneous element selected from a lanthanide element, a rare earth element, and an alkaline earth metal element. For example, the ceria-based ceramic oxide may be represented by Formula 1 below:

Ce₁₋ₐMₐO_{3±δ} Formula 1

In Formula 1 above, M is at least one selected from a lanthanide element, a rare earth element, and an alkaline earth metal element;

0<a≦0.3; and

δ is an excess or deficit of oxygen.

In an embodiment, δ may be 0≦γ≦0.3

In an embodiment, M may be at least one selected from lanthanum (La), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), calcium (Ca), strontium (Sr), barium (Ba), scandium (Sc), and yttrium (Y). Among these heterogeneous elements, ceria may be doped with Sc, Y, Sm, Gd, and the like. A combination containing a dopant may increase ion conductivity and thereby reduce cathode resistance. Examples of the ceria-based ceramic oxide may include Ce_{0.9}Gd_{0.1}O_{2-δ}, Ce_{0.8}Gd_{0.2}O_{2-δ}, Ce_{0.8}Sm_{0.2}O_{2-δ}, or the like.

The ceria-based ceramic oxide may have a fluorite structure.

The functional layer material for an SOFC may include the metal oxide, wherein the metal oxide may undergo a heat-treatment to form a liquid phase at an interface with the ceria-based ceramic oxide.

In general, when a functional layer material is coated and annealed on an electrolyte layer that has already been sintered, densification of a functional layer may be carried out. When an annealing temperature is increased in order to increase a density of a functional layer, an insulated layer may be formed due to a reaction between the functional layer and an electrolyte layer. To carry out this transformation, the annealing temperature may be equal to or less than about 1300° C. In order to ensure adhesion between an electrolyte and a cathode, the annealing temperature may be equal to or greater than about 1200° C. Thus, when a functional layer material is coated and sintered to form a functional layer, it is desirable to densify the functional layer at a temperature in a range of about 1200° C. to about 1300° C. When the temperature is in the foregoing range, the metal oxide forms a liquid phase at an interface with the ceria-based ceramic oxide. As a result, the functional layer may be formed which includes large particles and a dense structure by being sintered at a relatively low temperature.

During that process, either a solid-liquid interface may be formed to facilitate the movement of materials compared to diffusion of materials at a solid-vapor interface, or a structure of an interface may be changed to reduce a driving force of critical growth, thereby obtaining growth of particles.

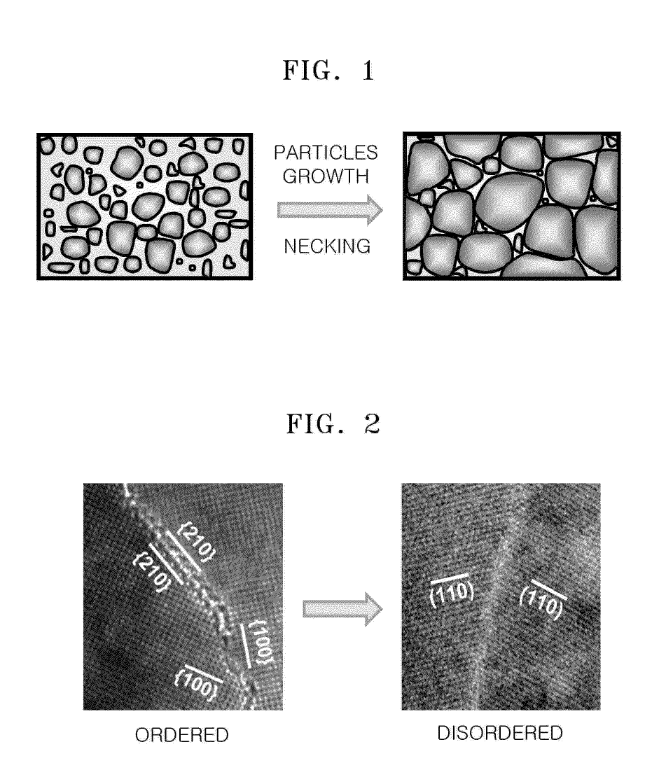

FIG. 1 shows a process wherein particles of the ceria-based ceramic oxide are grown and densified by adding the metal oxide. As shown in FIG. 1, when the functional layer material is annealed, particles of the functional layer material are rearranged due to a presence of a liquid phase between them. Thus space between the particles becomes filled and the functional layer material becomes densified. In the functional layer material, a liquid phase may be formed wherein the small particles may be dissolved. However, large particles may be precipitated again and, therefore, growth of particles may proceed continually. In addition, necking between particles may close the pores.

FIG. 2 is a scanning electron microscopy (“SEM”) image showing a change in a structure of an interface due to the added metal oxide. As shown in FIG. 2, a crystalline structure of an interface is changed by adding the metal oxide to reduce a driving force of critical growth and to obtain growth of particles.

When the functional layer material is completely annealed, metal components included in the metal oxide are uniformly doped in the ceria-based ceramic oxide to form a dense structure having large particles.

A metal element of the metal oxide for forming a liquid phase in the ceria-based ceramic oxide may readily form a liquid phase when the absolute value |X| of the Vegard's slope X represented by Equation 1 above increases.

According to an embodiment, the absolute value |X| of the Vegard's slope X of the metal element included in the metal oxide may be 27×10⁵≦|X|≦45×10⁵. When the absolute value |X| of the Vegard's slope X of the metal element is in the foregoing range, cell performance may be improved. The reason for the zirconium exclusion is that among metal elements, Zr may form a nonconductor reaction phase with ceria under this condition, and thus Zr is excluded.

The metal oxide may, for example, be at least one selected from, for example, ZnO, Bi₂O₃, and Co₃O₄.

Without wanting to be bound by a theory, when the amount of the metal oxide is too high, growth of particles occurs very rapidly depending on the added metal oxide and the metal oxide becomes excessively sintered. Also, when the amount of the metal oxide is too high, the metal oxide may not form a compound with ceria and remaining particles may interfere with growth of particles. When the amount of the metal oxide is too low, a liquid phase may not be smoothly formed. Accordingly, a desirable amount of the metal oxide may be determined. For example, a desirable amount of the metal oxide may be in the range of about 0.1 parts by weight to about 1.0 part by weight, based on 100 parts by weight of the ceria-based ceramic oxide.

A functional layer for an SOFC according to an embodiment may be manufactured by using the above-described functional layer material. The functional layer may include a ceria-based ceramic oxide represented by Formula 2 below.

Ce_{1-a-b}MₐM′_{b}O_{3±δ} Formula 2

In Formula 2 above, M is at least one selected from a lanthanide element, a rare earth element, and an alkaline earth metal element;

M′ is a metal, except for zirconium, having a Vegard's slope X represented by Equation 1 below and having an absolute value |X|, wherein 25×10⁵≦|X|≦45×10⁵;

0<a≦0.3;

0<b≦0.01; and

δ is an excess or deficit of oxygen:

X=(0.0220rᵢ+0.00015zᵢ) (1)

In Equation 1, ri is an ionic radius difference between the metal and Ce4+, and zᵢ is a charge difference between the metal and Ce⁴⁺.

In an embodiment, δ may be 0≦γ≦0.3.

According to an embodiment, M may be at least one selected from La, Pr, Nd, Pm, Sm, Eu, Gd, Tb, Dy, Ho, Er, Tm, Yb, Lu, Ca, Sr, Ba, Sc, and Y.

M′ doped with the ceria-based ceramic oxide is a metal element of a metal oxide included in the functional layer material. According to an embodiment, M′ may be at least one selected from zinc (Zn), bismuth (Bi), and cobalt (Co).

The functional layer manufactured by using the above-described functional layer material with metal oxide has larger particles and a more dense structure compared to a ceria material without the metal oxide. For example, porosity of the functional layer may be in a range of about 10 volume % to about 20 volume %, based on a total volume of the functional layer. The functional layer having porosity in the foregoing range may be inserted between a perovskite-based cathode and a zirconia-based electrolyte in an SOFC so as to prevent elements of a cathode layer from being diffused and to effectively prevent a nonconductor reaction phase such as Ce—Zr—O from being formed.

An SOFC according to an embodiment may include a perovskite-based cathode, an anode disposed to face the cathode, and a zirconia-based solid oxide electrolyte disposed between the cathode and the anode, wherein the above-described functional layer is disposed between the cathode and the solid oxide electrolyte.

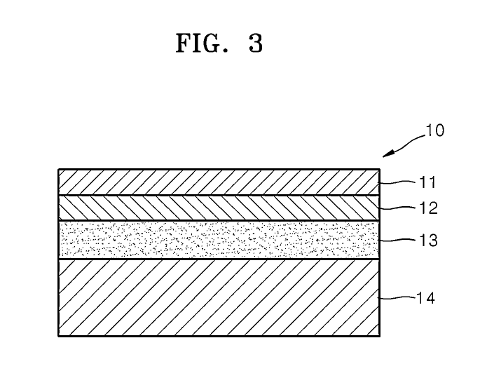

FIG. 3 is a cross-sectional view of an SOFC 10 according to an embodiment. Referring to FIG. 3, in the SOFC 10, a cathode 11 and an anode 14 are disposed on the opposite sides of a solid oxide electrolyte 13 and a functional layer 12 is inserted between the cathode 11 and the solid oxide electrolyte 13 in order to prevent a reaction therebetween.

The cathode (air electrode) 11 may reduce oxygen gas into oxygen ions and may allow air to continuously flow to the cathode 11 to maintain a constant partial oxygen pressure. A material for the cathode 11 may not be particularly limited as long as the material is generally used in the art. For example, the cathode 11 may be formed of, for example, a metal oxide particle having a perovskite-type crystalline structure. The perovskite-type metal oxide may be a mixed ionic and electronic conductor (“MIEC”) having both ionic conductivity and electronic conductivity. Due to a high oxygen diffusion coefficient and a high charge-exchange reaction rate constant, MIECs may induce a reduction reaction of oxygen on an entire electrode surface as well as at a triple phase boundary area, which results in high electrode activity at low temperatures, contributing to lowering an operating temperature of SOFCs. The perovskite-type metal oxide may be represented by Formula 3 below.

ABO_{3±γ} Formula 3

In Formula 3, A is at least one selected from La, Ba, Sr, Sm, Gd, and Ca; B is at least one element selected from Mn, Fe, Co, Ni, Cu, Ti, Nb, Cr, and Sc; and γ is an excess or deficit of oxygen.

In an embodiment, γ may be 0≦γ≦0.3.

For example, the perovskite-type metal oxide may be represented by Formula 4 below.

A′₁₋ₓA″ₓB′O_{3±γ} Formula 4

In Formula 4, A′ is at least one selected from barium (Ba), lanthanum (La), and samarium (Sm);

A″ is different from A′, and is at least one selected from strontium (Sr), calcium (Ca), and barium (Ba);

B′ is at least one selected from manganese (Mn), iron (Fe), cobalt (Co), nickel (Ni), copper (Cu), titanium (Ti), niobium (Nb), chromium (Cr), and scandium (Sc);

0≦x<1; and

γ is an excess or deficit of oxygen.

In an embodiment, γ may be 0≦γ≦0.3.

Examples of the perovskite-type metal oxide include at least one selected from barium strontium cobalt iron oxide (“BSCF”), lanthanum strontium cobalt oxide (“LSC”), lanthanum strontium cobalt iron oxide (“LSCF”), lanthanum strontium chromium manganese oxide (“LSCM”), lanthanum strontium manganese oxide (“LSM”), lanthanum strontium iron oxide (“LSF”), and samarium strontium cobalt oxide (“SSC”).

Specifically, the perovskite-type metal oxide may be Ba₁₋ₓSrₓCo_{1-y}Fe_{y}O₃ (wherein 0.1≦x≦0.5 and 0.05≦y≦0.5), BaₐSr_{b}CoₓFe_{y}Z_{1-x-y}O_{3±γ} (wherein Z is at least one selected from a transition metal element and a lanthanide element, 0.4≦a≦0.6, 0.4≦b≦0.6, 0.6≦x≦0.9 and 0.1≦y≦0.4), La₁₋ₓSrₓFe_{1-y}Co_{y}O_{3±γ} (wherein 0.1≦x≦0.4 and 0.05≦y≦0.5), Sm₁₋ₓSrₓCoO₃ (wherein 0.1≦x≦0.5), or the like. For example, oxides such as Ba_{0.5}Sr_{0.5}Co_{0.8}Fe_{0.2}O_{3±γ}, Ba_{0.5}Sr_{0.5}Co_{0.8}Fe_{0.1}Z_{0.1}O_{3±γ} (where Z═Mn, Zn, Ni, Ti, Nb, or Cu), La_{0.6}Sr_{0.4}Co_{0.2}Fe_{0.8}O_{3±γ}, Sm_{0.5}Sr_{0.5}CoO₃, or the like may be used. These perovskite-type metal oxides may be used alone or in a combination thereof.

The cathode 11 may have a thickness of about 1 micrometer (“μm”) to about 100 μm. Specifically, the cathode 11 may have a thickness of about 5 μm to about 50 μm.

The cathode 11 may be sufficiently porous to facilitate diffusion of oxygen gas.

The functional layer 12 interposed between the cathode 11 and the solid oxide electrolyte 13 may be manufactured by using the above-described functional layer material for an SOFC. The functional layer 12 may have a thickness of about 1 μm to about 50 μm, specifically, about 2 μm to about 10 μm.

The solid oxide electrolyte 13 is desirably dense enough so that a gas and a fuel are not be mixed therein, and desirably has high oxygen ion conductivity and low electron conductivity. The electrolyte 13 desirably maintains the same physical properties over a large oxygen partial pressure range, because of a relatively large oxygen partial pressure gap between the cathode 11 and the anode 14 on the opposite sides of the electrolyte 13.

Materials for forming the solid oxide electrolyte 13 may be at least one selected from a zirconia-based material, a ((La, Sr)(Ga, Mg)O₃)-based (LSGM) material, or the like that are generally used in the art. For example, for the solid oxide electrolyte 13, at least one selected from a stabilized zirconia, such as yttria stabilized zirconia (“YSZ”), and scandia stabilized zirconia (“ScSZ”), or the like, may be used. In addition, a ((La, Sr)(Ga, Mg)O₃)-based (LSGM) material may further include an anode functional layer that comprises a material such as gadolinia-doped ceria (“GDC”) in order to prevent a reaction with Ni.

The solid oxide electrolyte 13 may range from about 10 nanometers (nm) to about 100 μm in thickness. Specifically, the solid oxide electrolyte 13 may range from about 100 nm to about 50 μm in thickness.

The anode 14 (fuel electrode) serves to electrochemically oxidize a fuel and deliver charges. The cathode catalyst for oxidizing the fuel desirably has suitable physical properties. The cathode catalyst is desirably chemically stable with the materials for forming the solid oxide electrolyte 13 and desirably has a coefficient of thermal expansion similar to that of the solid oxide electrolyte 13. The anode 14 may include a cermet comprising the material for forming the solid oxide electrolyte 13, such as nickel oxide, or the like. For example, if YSZ is used for the solid oxide electrolyte 13, a Ni/YSZ ceramic-metallic hybrid composite may be used for the anode 14. In addition, a Ru/YSZ cermet, or a pure metal, such as, but not limited to, nickel (Ni), Co, ruthenium (Ru), platinum (Pt), etc., may be used for the anode 14. The anode 14 may additionally include activated carbon if desired. The anode 14 may be porous in order for a fuel gas to easily diffuse into it.

The anode 14 may have a thickness of about 1 μm to about 1,000 μm. For example, the anode 14 may have a thickness of about 5 μm to about 100 μm.

According to an embodiment, the SOFC 10 may further include an electric current collector layer containing an electron conductor (not shown) on at least one side of the cathode 11, for example, on an outer side of the cathode 11. The electric current collector layer may serve as a current collector of a structure of the cathode structure 11.

For example, the electric current collector layer may include at least one selected from lanthanum cobalt oxide (LaCoO₃), lanthanum strontium cobalt oxide (“LSC”), lanthanum strontium cobalt iron oxide (“LSCF”), lanthanum strontium cobalt manganese oxide (“LSCM”), lanthanum strontium manganese oxide (“LSM”), and lanthanum strontium iron oxide (“LSF”). The electric current collector layer may be formed using the materials described above alone or in a combination with each other. In some embodiments, a single-layered structure or a stacked structure of at least two multiple layers may be formed from these materials.

The SOFC 10 may be manufactured using any suitable operating process disclosed in literature, and thus, a detailed description thereof will not be repeated herein. The SOFC 10 may be applied to a variety of structures, for example, a tubular stack, a flat tubular stack, or a planar stack.

Hereinafter, one or more embodiments of the present disclosure will be described in detail with reference to the following examples. These examples shall not limit the purpose and scope of the disclosed embodiment.

Manufacture of Symmetrical Cell for Measuring Cathode Resistance (Area Specific Resistance, “ASR”)

### EXAMPLE 1

In order to measure cathode resistance (area specific resistance, “ASR”), a symmetrical cell was manufactured by sequentially coating a pair of functional layers and a pair of cathode layers on the opposite sides of an electrolyte layer.

When the symmetrical cell was manufactured, the electrolyte layer was formed by using a scandia stabilized zirconia (“ScSZ”)(Zr_{0.8}Sc_{0.2}O₂) (FCM, USA) powder. Specifically, 1.5 g of the powder was quantified, placed into a metal mold having a diameter of 1 centimeter (cm), and uniaxially pressed at a pressure of about 200 megapascals (MPa). The pressed pellet was sintered for 8 hours at a temperature of 1550° C. to prepare an electrolyte material having a coin shape with a thickness of 1 millimeter (mm). Subsequently, the electrolyte layer was formed of the electrolyte material.

In order to form the functional layers on opposite sides of the electrolyte layer, the following processes were performed. Co₃O₄ (m.p. 895° C., Vegard's slope of Cu²⁺ dopant=−45×10⁵) was mixed with gadolinia-doped ceria (“GDC”) (Ce_{0.9}Gd_{0.1}O₂) (FCM, USA) in a ratio of 0.5 percent by weight (wt %). The mixture powder was added to an available FCM Ink vehicle (“VEH”) solvent in a weight ratio of 3:2 and the resultant composition was uniformly mixed to yield a slurry. The slurry was screen-printed on the opposite sides of the sintered electrolyte layer by using a screen of 40 μm. Subsequently, the resulting material was sintered at a temperature of 1250° C. for three hours to manufacture the functional layers.

In order to form the cathode layers, a mixture powder of Ba_{0.5}Sr_{0.5}Co_{0.8}Fe_{0.1}Zn_{0.1}O_{3-γ} and La_{0.6}Sr_{0.4}Co_{0.2}Fe_{0.8}O_{3-γ} (FCM, USA) was used as a cathode material. In this case, Ba_{0.5}Sr_{0.5}Co_{0.8}Fe_{0.1}Zn_{0.1}O_{3-γ} was synthesized by using a Urea-PVA method. In detail, Ba(NO₃)₂, Sr(NO₃)₂, Co(NO₃)₂, Fe(NO₃)₃, Zn(NO₃)₂, in a molar ratio of 0.5:0.5:0.8:0.1:0.1:3.5 were quantified. Then, PVA was quantified to have the same mass as that of the urea. Subsequently, a total of 1,063.1 g of all the quantified materials was added to a 50 liter (“L”) reactor for liquid phase materials equipped with an agitator. Deionized water (10 L) was added to the reactor. The materials contained in the reactor were heated to 200° C. upon stirring, and at that temperature, the materials were left for 3 hours. As a result, a gelled product was obtained. Subsequently, the gelled product was placed in an aluminum crucible and dried in an oven at a temperature of 100° C. for 24 hours. The dried product was calcined at a temperature of 1000° C. for 5 hours and the sintered product was pulverized by using a planetary ball mill at a speed of 2,000 revolutions per minute (“rpm”) for 24 hours. The pulverized product was dried in an oven to obtain a target powder, Ba_{0.5}Sr_{0.5}Co_{0.8}Fe_{0.1}Zn_{0.1}O_{3-δ} (hereinafter, referred to as ‘BSCFZ’ in the Examples, wherein δ is a value that makes a metal oxide represented by this formula have electrical neutrality).

A mixed powder obtained by quantifying Ba_{0.5}Sr_{0.5}Co_{0.8}Fe_{0.1}Zn_{0.1}O_{3-δ} and La_{0.6}Sr_{0.4}Co_{0.2}Fe_{0.8}O_{3-δ} in a weight ratio of 1:1 and the available FCM Ink vehicle (“VEH”) were quantified at a weight ratio of 2:3 and were uniformly mixed in a mortar to prepare a cathode material forming slurry. The cathode material forming slurry prepared above was screen printed on a pair of functional layers by using a 40 ,μm screen. Subsequently, the resultant material was dried in an oven at a temperature of 100° C. and then sintered in a calcining furnace at a temperature of 900° C. in an air atmosphere for 2 hours to form the cathode layers.

### EXAMPLE 2

A symmetrical cell was prepared in the same manner as described in Example 1, except that a functional layer was formed by using ZnO (melting point (“m.p.”) 1975° C., Vegard's slope of Zn²⁺ dopant=−45×10⁵) instead of Co₃O₄ as in Example 1.

### EXAMPLE 3

A symmetrical cell was prepared in the same manner as in Example 1, except that a functional layer was formed by using Bi₂O₃ (m.p. 817° C., Vegard's slope of Bi³⁺ dopant=29×10⁵) instead of Co₃O₄ as in Example 1.

### COMPARATIVE EXAMPLE 1

A symmetrical cell was prepared in the same manner as in Example 1, except that Co₃O₄ was not added when a functional layer was formed.

### COMPARATIVE EXAMPLE 2

A symmetrical cell was prepared in the same manner as in Example 1, except that a functional layer was formed by using MnO₂ (m.p. 535° C., Vegard's slope of Mn²⁺ dopant=−32×10⁵) instead of Co₃O₄ as in Example 1.

### COMPARATIVE EXAMPLE 3

A symmetrical cell was prepared in the same manner as in Example 1, except that a functional layer was formed by using In₂O₃ (m.p. 1910° C., Vegard's slope of In³⁺ dopant=−26×10⁵) instead of Co₃O₄ as in Example 1.

### COMPARATIVE EXAMPLE 4

A symmetrical cell was prepared in the same manner as in Example 1, except that a functional layer was formed by using CuO (m.p. 1201° C., Vegard's slope of Cu²⁺ dopant=−48) instead of Co₃O₄ used in Example 1.

Manufacture of Tubular Cell for Measuring Cell Performance

### EXAMPLE 4

An anode support, serving as an anode, was manufactured to have a tubular shape (diameter: 30 mm, thickness: 1 mm) by an extrusion method using a complex material obtained by mixing NiO and YSZ (Zr_{0.84}Y_{0.16}O₂).

YSZ % (10 mol % of Sc₂O₃-doped ZrO₂) was dip-coated to a thickness of 20 μm as a slurry on the anode supporter and was sintered at a temperature of 1400° C. to form a solid electrolyte (“SE”).

In order to manufacture a functional layer, an available GDC powder and Co₃O₄ were mixed to form a slurry, coated on the SE by dip-coating, and then heat-treated at a temperature of 1200° C.

A mixture powder of Ba_{0.5}Sr_{0.5}Co_{0.8}Fe_{0.1}Zn_{0.1}O_{3-γ} and La_{0.6}Sr_{0.4}Co_{0.2}Fe_{0.8}O_{3-γ} was prepared as a slurry, dip-coated on a heat-treated ceria layer, and heat-treated at a temperature of 900° C. to manufacture a cell. In this case, the area of a cathode layer was 34.5 square centimeters (cm²).

### EXAMPLE 5

A cell was manufactured in the same manner as in Example 4, except that a functional layer was formed by using ZnO instead of Co₃O₄ as in Example 4.

### EXAMPLE 6

A cell was manufactured in the same manner as in Example 4, except that a functional layer was formed by using Bi₂O₃ instead of Co₃O₄ as in Example 4.

### COMPARATIVE EXAMPLE 5

A cell was manufactured in the same manner as in Example 4, except that Co₃O₄ was not added when a functional layer was formed.

### COMPARATIVE EXAMPLE 6

A cell was manufactured in the same manner as in Example 4, except that a functional layer was formed by using MnO₂ instead of Co₃O₄ as in Example 4.

### COMPARATIVE EXAMPLE 7

A cell was manufactured in the same manner as in Example 4, except that a functional layer was formed by using In₂O₃ instead of Co₃O₄ as in Example 4.

### COMPARATIVE EXAMPLE 8

A cell was manufactured in the same manner as in Example 4, except that a functional layer was formed by using CuO instead of Co₃O₄ as in Example 4.

### EVALUATION EXAMPLE 1

### Analysis of SEM of Sectional View of Cell and EDS Between Electrolyte Layer and Functional Layer

In order to analyze microstructures of a GDC functional layer having no additives and a GDC functional layer including additives, as well as components between an electrolyte (“ScSZ”) and a functional layer (“GDC”), scanning electron microscope (“SEM”) capturing and energy dispersive X-ray spectrometry (“EDS”) were performed on the cells manufactured in Comparative Example 5 and Example 4.

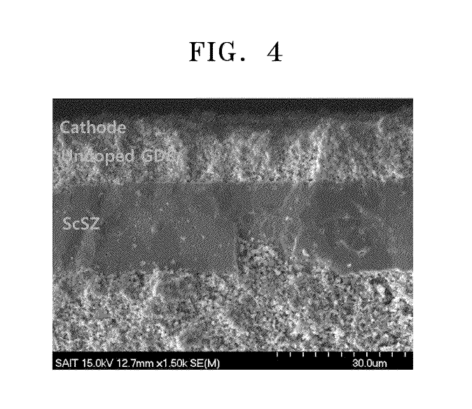

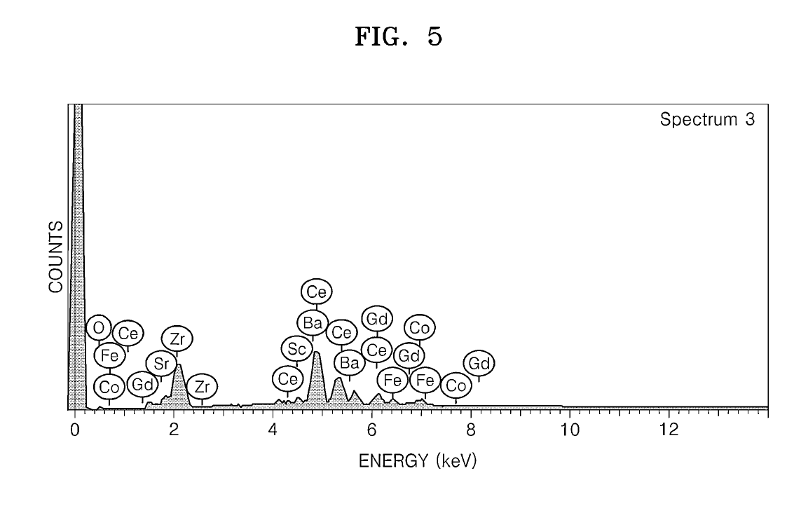

FIG. 4 is an SEM image of a sectional view of the cell of Comparative Example 5 wherein a functional layer was formed by using a GDC slurry having no additives. FIG. 5 shows an EDS analysis result of components between the electrolyte (“ScSZ”) and the functional layer (“GDC”).

Referring to FIGS. 4 and 5, in the cell manufactured in Comparative Example 4, since the GDC functional layer and a porous cathode layer have similar density values, the GDC functional layer and the porous cathode layer are almost not distinguishable from each other. In addition, since the GDC functional layer has high porosity and large pores, elements of a cathode penetrate into the GDC functional layer. Thus, via the EDS analysis, it is determined that the elements of the cathode are detected between the GDC functional layer and a zirconia electrolyte layer. In this example, a reaction phase of the elements between the zirconia electrolyte layer and the cathode is formed to reduce performance of the cell. Since a slurry containing a functional layer material was coated in a slurry state on an ScSZ electrolyte layer, which is densified and completely contracted, the functional layer had low initial density. In addition, since the functional layer is heat-treated at a low temperature of 1200° C., the elements are barely densified, thereby reducing ion conductivity of a ceria functional layer and interfering in preventing a reaction between the cathode layer and the zirconia electrolyte layer.

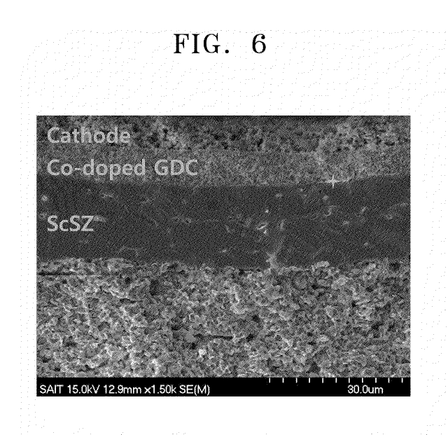

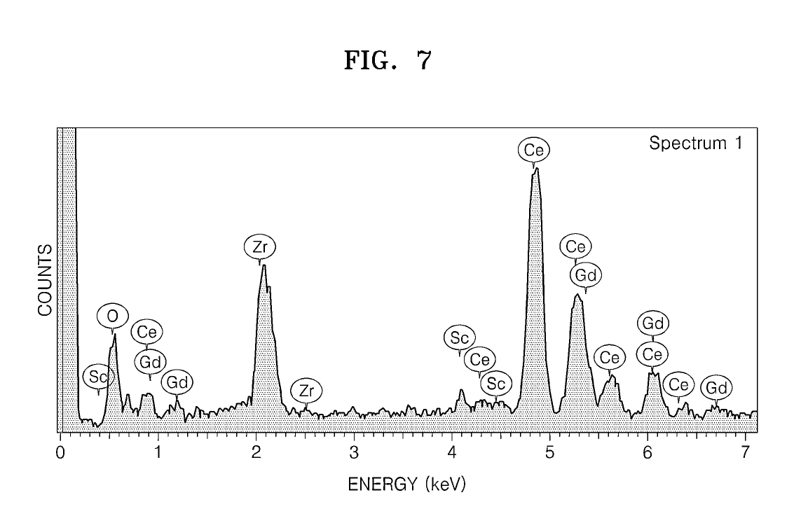

FIG. 6 shows an SEM image of a sectional view of the cell of Example 4 in which a functional layer is formed by using a GDC slurry including Co₃O₄. FIG. 7 shows an EDS analysis result of the components between the electrolyte (“ScSZ”) and the functional layer (“GDC”).

Referring to FIGS. 6 and 7, compared to Comparative Example 4 wherein the GDC functional layer and a porous cathode layer are almost not distinguishable from each other due to similar density values, it may be confirmed that the functional layer of Example 4 has a microstructure having a higher density due to added Co and thus the cathode layer and the GDC functional layer are distinguishable from each other. In this case, via the EDS analysis, it may be determined that a function of a functional layer is effectively performed since elements of the cathode layer are detected between the zirconia electrolyte layer and the GDC functional layer.

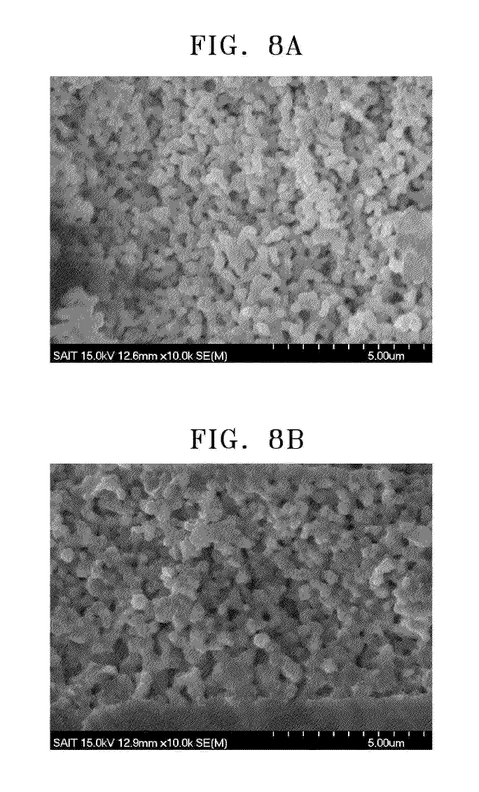

FIGS. 8A and 8B show a comparison of SEM images of the GDC functional layer (a) having no additives of Comparative Example 5 and the GDC functional layer (b) including Co₃O₄ of Example 4. Referring to FIGS. 8A and 8B, it may be determined that, when Co is included, the sizes of particles are greater than those in a case having no additives. It may be confirmed that, when a liquid phase is formed due to a small amount of Co, a solid-liquid interface may be formed to facilitate movement of materials compared to diffusion of materials at a solid-vapor interface, or a structure of an interface may be changed to reduce a driving force of critical growth, thereby obtaining growth of particles.

### EVALUATION EXAMPLE 2

### Measurement of Current-Voltage and Output Density

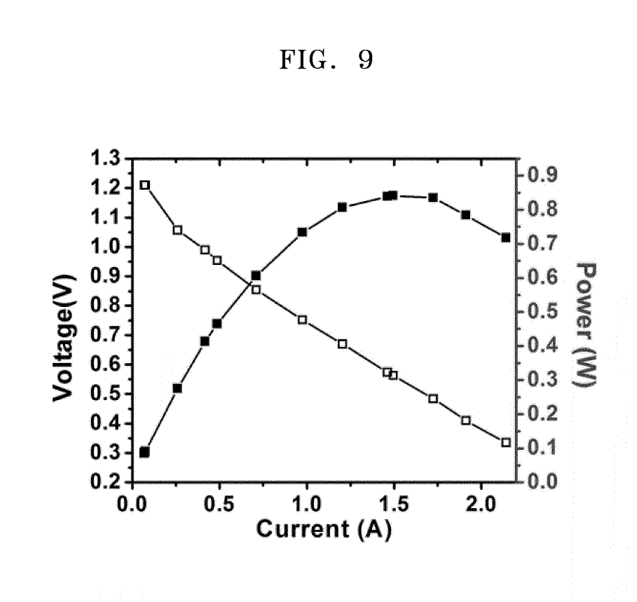

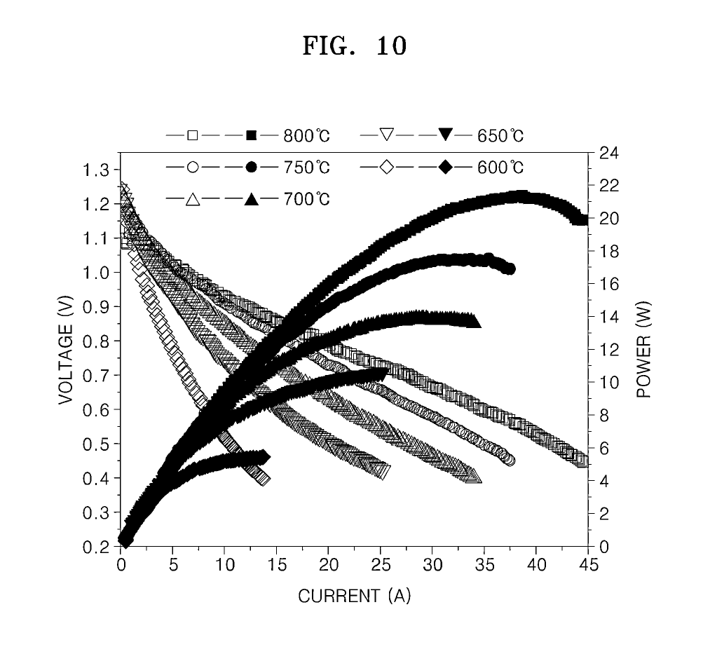

I-V and I-P characteristics (wherein I is current, V is voltage, and P is power density) of the cells of Comparative Example 5 and Example 4 were measured. As oxygen was supplied to an air electrode (cathode) and hydrogen gas was applied to a fuel electrode (anode), an open circuit voltage (“OCV”) of 1V or greater was obtained. To obtain I-V data, voltage drops were measured as a current increased from 0 Ampere (“A”) to several Amperes until the voltage reached 0V. I-P data were calculated from the I-V data. The resulting I-V and I-P data are shown in FIGS. 9 and 13. In FIGS. 9 and 10, white-dotted plots are of I-V relationships at different temperatures, and black-dotted plots are of output density calculated from the I-V plots.

FIG. 9 is a current-voltage (I-V) graph showing performance of the cell of Comparative Example 5 using a GDC functional layer having no additives. FIG. 10 is an I-V graph showing performance of the cell of Example 4 using a GDC functional layer including Co₃O₄.

Referring to FIGS. 9 and 10, when a cell is manufactured by using a GDC slurry that does not contain Co₃O₄, a maximum output performance of the cell at a temperature of 800° C. has a low value of about 0.9 Watts (“W”). On the other hand, when a cell is manufactured by using a slurry that contains a small amount of Co₃O₄, relatively excellent performance is obtained. That is, a maximum output performance at 800° C. is about 22 W and a maximum output density at 700° C. is increased to about 0.405 Watts per square centimeter (“W/cm²”).

### EVALUATION EXAMPLE 3

### Analysis of Cathode Resistance Due to Added Elements

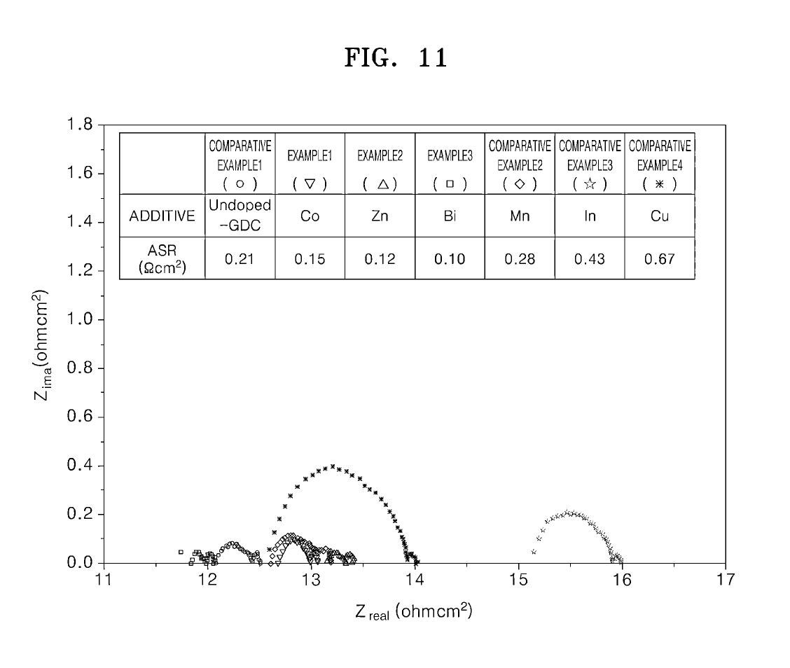

In order to check cathode resistance with regard to added elements, impedances of the symmetrical cells of Examples 1-3 and Comparative Examples 1-4 were measured under air atmosphere and the results are shown in FIG. 11. A device used in the impedance analysis was a Materials mates 7260 of Materials Mates company. The operating temperature of the cells was 700° C. In FIG. 11, the size (diameter) of semicircles indicates a level of the positive electrode resistance (R_{ca}). The measured cathode resistance is shown in Table 1 below.

TABLE 1

| | | cathode resistance (area |
|---|---|---|
| | Additive of GDC | specific resistance, ASR) at |
| | functional layer | 700° C. (ohmcm²) |
| Comparative Example 1 | Un-doped GDC | 0.21 |
| Example 1 | Co | 0.15 |
| Example 2 | Zn | 0.12 |
| Example 3 | Bi | 0.10 |
| Comparative Example 2 | Mn | 0.28 |
| Comparative Example 3 | In | 0.43 |
| Comparative Example 4 | Cu | 0.67 |

As shown in FIG. 11 and Table 1 above, when GDC without a dopant is used, cathode resistance (area specific resistance, “ASR”) is 0.21 (ohms-square centimeters, Ωcm²). However, like in Examples 1-3, a microstructure of the GDC functional layer is developed by further doping Co, Zn, and Bi elements with a metal element having a Vegard's slope X having an absolute value |X|, wherein 25×10⁵≦|X|≦45×10⁵, and thus cathode resistance is reduced to about 0.1 Ohm (Ω). When Mn, In, or Cu is further doped on the GDC functional layer, cathode resistance is remarkably increased.

### EVALUATION EXAMPLE 4

### Analysis of Microstructure of Functional Layer According to Added Elements

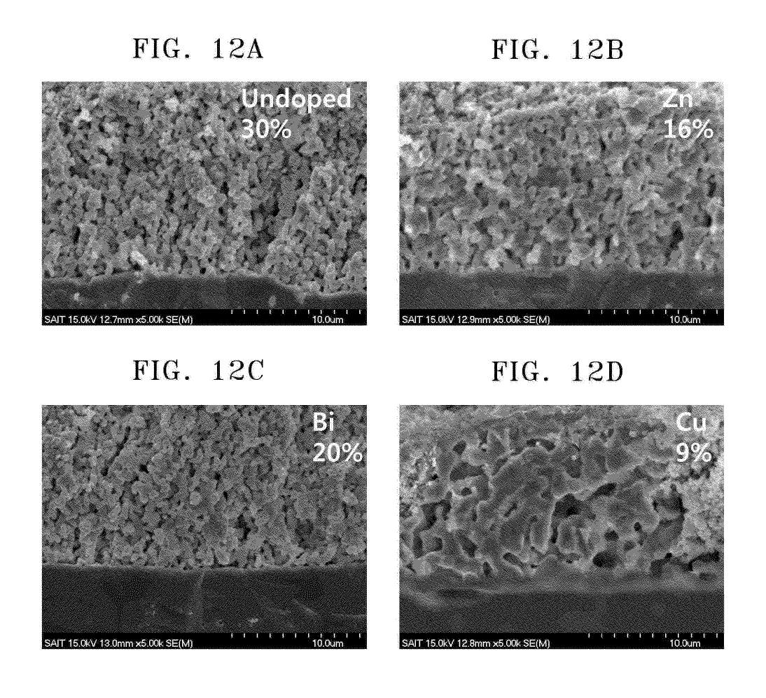

In order to check a microstructure of a functional layer according to added elements, a GDC functional layer of the symmetrical cells of Examples 2 and 3 and Comparative Examples 1 and 4 was enlarged and analyzed by an SEM. In addition, porosity of the functional layer was measured by Image Analyzer. Enlarged SEM images of the GDC layers are compared and shown in FIG. 12. Porosity of the GDC layers is shown in Table 2 below.

TABLE 2

| | Additive of GDC | |
|---|---|---|
| | functional layer | Porosity (volume %) |
| Comparative Example 1 | Un-doped GDC | 30 |
| Example 2 | Zn | 16 |
| Example 3 | Bi | 20 |
| Comparative Example 4 | Cu | 9 |

As shown in FIGS. 12A-12D and Table 2 above, when Zn, Bi, and Cu are further doped compared to a case having no additives, the porosity of the GDC functional layer is reduced. When Cu elements are added, the sizes of particles of the functional layer are increased and the functional layer has a dense structure, thereby increasing ion conductivity. However, ions of some elements of the cathode are easily diffused to interfere, and thus a function of preventing a reaction is not properly performed.

As described above, according to above embodiments of the present disclosure, a functional layer material for an SOFC may be used to manufacture a functional layer that not only may have a dense structure and but also may prevent a reaction phase from being formed between the functional layer and an electrolyte. The functional layer may effectively prevent a reaction between a cathode of the SOFC and the electrolyte, thereby reducing cathode resistance.

It should be understood that exemplary embodiments described herein should be considered in a descriptive sense only and not for purposes of limitation. Descriptions of features or aspects within each embodiment should typically be considered as available for other similar features, advantages, or aspects in other embodiments.

What is claimed is:

1. A functional layer material for a solid oxide fuel cell comprising:
a ceria ceramic oxide; and
a metal oxide comprising a metal, except for zirconium, having a Vegard's slope X represented by Equation 1 and having an absolute value |X| of the Vegard's slope X that satisfies 27×10⁵≦|X|≦45×10⁵:
X=(0.0220rᵢ+0.00015zᵢ) (1),
wherein rᵢ is an ionic radius difference between the metal and Ce⁴⁺, and
zᵢ is a charge difference between the metal and Ce⁴⁺.

2. The functional layer material of claim 1, wherein the metal oxide forms a liquid phase at an interface with the ceria ceramic oxide when heat-treated.

3. The functional layer material of claim 2, wherein a heat treatment temperature is from about 1,200 to about 1,300° C.

4. The functional layer material of claim 1, wherein the metal oxide comprises at least one selected from ZnO, Bi₂O₃, and Co₃O₄.

5. The functional layer material of claim 1, wherein the ceria ceramic oxide comprises at least one heterogeneous element selected from a lanthanide element, a rare earth element, and an alkaline earth metal element as a dopant.

6. The functional layer material of claim 1, wherein the ceria ceramic oxide is represented by Formula 1:
Ce₁₋ₐMₐO_{3±γ}, Formula 1
wherein M is at least one selected from a lanthanide element, a rare earth element, and an alkaline earth metal element;
0<a≦0.3, and
γ is an excess or a deficit of oxygen.

7. The functional layer material of claim 6, wherein M is at least one selected from lanthanum, praseodymium, neodymium, promethium, samarium, europium, gadolinium, terbium, dysprosium, holmium, erbium, thulium, ytterbium, lutetium, calcium, strontium, barium, scandium, and yttrium.

8. The functional layer material of claim 1, wherein the ceria ceramic oxide has a fluorite structure.

9. The functional layer material of claim 1, wherein the metal oxide is contained in an amount of about 0.1 to about 1.0 parts by weight, based on 100 parts by weight of the ceria ceramic oxide.

10. A functional layer for a solid oxide fuel cell comprising a ceria ceramic oxide represented by Formula 2:
Ce_{1-a-b}MₐM′_{b}O_{3±δ}, Formula 2
wherein M is at least one selected from a lanthanide element, a rare earth element, and an alkaline earth metal element;
M′ is a metal, except for Zr, having a Vegard's slope X represented by Equation 1 and having an absolute value |X| of the Vegard's slope X, wherein 25×10⁵≦|X|≦45×10⁵;
0<a≦0.3;
0<b≦0.01; and
δ is an excess or a deficit of oxygen:
X=(0.0220rᵢ+0.00015zᵢ) (1)
wherein rᵢ is an ionic radius difference between the metal and Ce⁴⁺, and
zᵢ is a charge difference between the metal and Ce⁴⁺.

11. The functional layer of claim 10, wherein M is at least one selected from La, Pr, Nd, Pm, Sm, Eu, Gd, Tb, Dy, Ho, Er, Tm, Yb, Lu, Ca, Sr, Ba, Sc, and Y.

12. The functional layer of claim 10, wherein M′ is at least one selected from Zn, Bi, and Co.

13. The functional layer of claim 10, wherein a porosity of the functional layer is about 10 to about 20 volume %, based on a total volume of the functional layer.

14. A solid oxide fuel cell comprising:
a cathode;
an anode facing the cathode; and
a solid oxide electrode disposed between the cathode and the anode,
wherein the functional layer of claim 10 is disposed between the cathode and the solid oxide electrolyte.

15. The solid oxide fuel cell of claim 14, wherein the cathode comprises a perovskite-type metal oxide represented by Formula 3:
ABO_{3±γ}, Formula 3
wherein A is at least one selected from La, Ba, Sr, Sm, Gd, and Ca;
B is at least one selected from Mn, Fe, Co, Ni, Cu, Ti, Nb, Cr, and Sc; and
γ is an excess or deficit of oxygen.

16. The solid oxide fuel cell of claim 15, wherein the perovskite-type metal oxide is represented by Formula 4:
A′₁₋ₓA″ₓB′O_{3±γ}, Formula 4
wherein A′ is at least one selected from Ba, La, and Sm;
A″ is different from A′ and is at least one selected from Sr, Ca, and Ba;
B′ is at least one selected from Mn, Fe, Co, Ni, Cu, Ti, Nb, Cr, and Sc;
0≦x<1; and
γ is an excess or deficit of oxygen.

17. The solid oxide fuel cell of claim 14, wherein the solid oxide electrolyte comprises at least one selected from yttria stabilized zirconia, scandia stabilized zirconia, and a ((La, Sr)(Ga, Mg)O₃) material.

18. The solid oxide fuel cell of claim 14, further comprising a nonconductor reaction phase disposed between the functional layer and the solid oxide electrolyte, wherein a thickness of the nonconductor reaction phase is about 0.5 micrometers or less.

19. The solid oxide fuel cell of claim 14, wherein M is at least one selected from La, Pr, Nd, Pm, Sm, Eu, Gd, Tb, Dy, Ho, Er, Tm, Yb, Lu, Ca, Sr, Ba, Sc, and Y.

20. The solid oxide fuel cell of claim 14, wherein M′ is at least one selected from Zn, Bi, and Co.
